(19) United States
(12) Patent Application Publication
(10) Pub. No.: US 2007/0263110 A1
(43) Pub. Date: Nov. 15, 2007

(54) Method for driving solid-state image sensor

(75) Inventors: Kazutaka Itsumi, Kuwana-shi (JP); Kenichi Shirai, Toyohashi-shi (JP)

Correspondence Address: OLIFF & BERRIDGE, PLC, P.O. BOX 19928, ALEXANDRIA, VA, 22320, US

(73) Assignee: SANYO ELECTRIC CO., LTD., MORIGUCHI-SHI (JP)

(21) Appl. No.: 11/790,229

(22) Filed: Apr. 24, 2007

(30) Foreign Application Priority Data
Apr. 26, 2006 (JP) 2006-122071

(51) Int. Cl. H04N 5/335

(52) U.S. Cl. 348/311

(57) ABSTRACT

In a line transfer operation of a frame-transfer CCD image sensor, color mixing that occurs when charges trapped by interface states are released in subsequent bits, and longitudinal striping due to trapping a the horizontal transfer period can be reduced. A line transfer operation (t₁ to t₆) in a storage section, which is composed of three-phase driven vertical CCD shift registers in which transfer electrodes ST1 to ST3 are arrayed, is ended in a state in which information charges are stored only under the transfer electrode ST2. This state continues until the completion of a horizontal transfer period P₀ of the information charge packet groups of the odd-numbered columns. At this time, an off-voltage that is lower than normal is applied to the transfer electrodes ST1 and ST3, and an inverted layer is formed on the surface of the substrate under the transfer electrodes. Next, the information charge packets held in the storage section store under the transfer electrodes ST2 and ST3 in the period that begins at the start of the horizontal transfer period P_{E} of the information charge packet groups of the even-numbered columns and ends at the start of the next line transfer operation.

### CROSS-REFERENCE TO RELATED APPLICATION

The priority application number JP2006-122071 upon which this patent application is based is hereby incorporated by the reference.

### BACKGROUND OF THE INVENTION

1. Field of the Invention

The present invention relates to a method for driving a solid-state image sensor that performs vertical transfers one bit at a time in vertical CCD shift registers each time a single row (line) of information charge is read.

2. Description of the Related Art

A frame-transfer CCD image sensor includes an imaging section and a storage section. The imaging section and storage section are each composed of a plurality of vertical CCD shift registers that include a plurality of charge transfer channel regions that extend in the vertical direction (column direction) and are disposed parallel to each other, and a plurality of transfer electrodes that extend in the horizontal direction (row direction) and are disposed parallel to each other. Each bit of the vertical CCD shift registers includes a plurality of transfer electrodes disposed adjacent to each other, and forms a potential well in which information charges are stored by the application of voltage to the transfer electrodes.

The bits of the vertical CCD shift registers of the imaging section constitute the pixels of image sensor, receive light from a photographic subject during an exposure period, generate information charges corresponding to the amount of light received, and accumulate the charges in a potential well. The information charges are vertically transferred at high speed from the imaging section to the storage section by a frame transfer operation when the exposure period is completed.

The storage section is shielded from light and can therefore hold information charges. The storage section carries out a line transfer operation and moves the information charges toward the horizontal transfer section each time the horizontal transfer section completes a horizontal transfer of a single row of information charges to the output section.

A CCD image sensor structure such as that disclosed in Japanese Laid-open Patent Application No. 2006-073988 is known. In this structure, a mechanism is provided that distributes the information charges between a horizontal transfer section and the output terminals of vertical CCD shift registers of the storage section. A single row of information charge packets outputted from the vertical CCD shift registers of the storage section can be separated into an odd-numbered information charge packet group consisting of information charge packets outputted from odd-numbered-column vertical CCD shift registers and an even-numbered information charge packet group consisting of information charge packets outputted from even-numbered-column vertical CCD shift registers and transferred to the horizontal transfer section. In this configuration, the horizontal CCD shift register constituting the horizontal transfer section performs separate horizontal transfer operations for the odd-numbered information charge packet group and the even-numbered information charge packet group to complete the horizontal transfer operation for a single row of information charge packets. FIG. 1 is a timing chart showing a conventional method for driving a frame-transfer CCD image sensor having this distribution mechanism. The drawing also shows the wave forms of the clock signals that drive the storage section and the horizontal transfer section. FIG. 2 is a schematic diagram showing the change in channel potential under transfer electrodes at each point in time shown in FIG. 1. In FIG. 2, the downward direction is the positive orientation of the channel potential, the solid line represents the change in the depth of the potential along the charge transfer channel, and the concave portion formed by the solid line is a potential well that can store an information charge packet composed of electrons. The vertical CCD shift registers of the storage section are a three-phase drive that uses three phase clock signals φ₁ to φ₃, and three transfer electrodes ST1 to ST3 are provided for each bit. The transfer electrodes ST1 to ST3 are aligned in sequence along the charge transfer direction, and the clock signal φᵢ (i=1 to 3) is applied to the transfer electrode ST1. When φᵢ is at a prescribed high voltage V_{H}, a potential well is formed under the transfer electrode STi, and an information charge can be stored. When φᵢ is at a prescribed low voltage V_{L}, a potential barrier that provides a partition between potential wells is formed under the transfer electrode STi. The clock signal φ_{H} drives the horizontal CCD shift register. The clock signal φ_{H} also has prescribed high and low voltage states in the same manner as φᵢ, and these states periodically change, whereby horizontal transfer of information charges is performed.

A line transfer operation is carried out in the period of time P₁, and the potential well formed under the transfer electrodes ST2 and ST3 of the bits of the vertical CCD shift registers of the storage section is moved to a location under the transfer electrodes ST2 and ST3 of the next bit. FIG. 2 shows the state of the potential well at times t₁ to t₇ within the period P₁. The information charges also move by a single bit within the vertical CCD shift registers.

Subsequent to the line transfer operation, a horizontal transfer operation is carried out in the period of time P₂. In the horizontal transfer operation, an operation for reading a group of information charge packets of odd-numbered columns into the horizontal CCD shift register is carried out first. The group of information charge packets of odd-numbered columns is then transferred to the output section by using the clock sequence of the continuously generated clock signal φ_{H} in the period P₀. An operation for reading a group of information charge packets of even-numbered columns into the horizontal CCD shift register is carried out in the period P₂ of the horizontal transfer operation. The group of information charge packets of even-numbered columns is then transferred to the output section by using the clock sequence of the continuously generated clock signal φ_{H} in the period P_{E}. When the horizontal transfer operation of a single row has been completed in this manner, the next line transfer is carried out in the period P₃.

The information charge packet held in each bit of the vertical CCD shift registers of the storage section is present in the potential well under the two transfer electrodes ST2 and ST3 in the entire period P₂ in which the horizontal transfer operation is carried out or at least in the period P₀ and P_{E}. Specifically, in conventional driving methods, the information charges of the bits of the vertical CCD shift registers of the storage section are held essentially under the transfer electrodes ST2 and ST3 where the information charges arrived by the line transfer at time t₇, from the end period of the preceding line transfer operation period P₁ until the beginning period of the subsequently line transfer operation period P₃.

In the buried channel CCD shift register, information charges are trapped by the interface states, and transfer efficiency may be reduced when the information charges accumulate up to the vicinity of the substrate surface. The interface state density is not uniform within the substrate surface. Therefore, in general, transfer efficiency therefore varies among the vertical CCD shift registers of the storage section. The differences in the transfer efficiency appear as longitudinal striping in a photographed image and cause image degradation.

The amount of charge that is trapped can be increased in accordance with the holding time of the state in which the information charges are accumulated up to the vicinity of the substrate surface. In the operation of the storage section described above, the holding operation of the information charge in the horizontal transfer period occurs for a longer period of time than the processes of the line transfer operation, and reducing trapping occurrences in this holding operation is therefore effective in reducing longitudinal striping.

A digital camera or other imaging device ordinarily takes still images at a high-definition image quality that corresponds to the number of pixels of solid state image sensors, and takes video images by skipping some pixels in order to maintain the desired frame rate. Still imaging, in which rows are read without skipping, can have a greater number of repetitions of line transfer operations and holding operations than video imaging, and longitudinal striping can be more marked due to the cumulative transfer efficiency of each repetition of the two operations. In contrast, higher image quality is required for still imaging than for video imaging, and longitudinal striping must be effectively reduced.

The information charges more easily approach the surface of a substrate as the planar dimension of the potential well is reduced when the information charges in the potential well are stored at a prescribed depth. Conversely, it is easier to maintain distance from the surface of the substrate as the planar dimension increases. In view of the above, the above-mentioned conventional driving method that forms each potential well holding information charges in the horizontal transfer period under two transfer electrodes, instead of only one transfer electrode, in a three-phase drive vertical CCD shift register of a storage section is effective for reducing longitudinal striping in still images with high efficiency.

In this manner, the conventional driving method holds the information charges under two transfer electrodes in the holding operation of the information charges in the horizontal transfer period in order to reduce trapping. However, midway through the line transfer operation, a short period of time exists in which information charge packets are stored under only one electrode, such as at times t₂, t₄, and t₆ of FIG. 2, and information charges may be trapped in such periods. The problem is that charges trapped under the transfer electrode of certain bits are released when the next information charge packet is moved under the transfer electrode by a line transfer, the trapped charge becomes mixed with the information charge packet, and the image quality becomes degraded. For example, in a configuration in which color filters of mutually different colors are disposed on vertically-adjoining pixels in the imaging section, trapped charges that become mixed produce a mixed color, and this color can be observed as degradation in the color balance on the display screen.

### SUMMARY OF THE INVENTION

The present invention provides a method for driving a solid-state image sensor whereby longitudinal striping is reduced, the mixing of trapped charges with information charges between vertically adjacent pixels is reduced as well, color mixing and other defects are avoided, and image quality is improved.

The present invention relates to a method for driving a solid-state image sensor having a plurality of n-phase (wherein n is a natural number of 3 or more) drivable vertical CCD shift registers in which information charge packets composed of information charges generated in a matrix of light-receiving pixels are vertically driven in the column direction, and a horizontal CCD shift register in which the information charge packets outputted from the plurality of vertical CCD shift registers are horizontally transferred in the row direction. The driving method of the present invention comprises a line transfer operation in which the information charge packets are vertically transferred one row at a time by moving the information charge packets in the vertical CCD shift registers one bit at a time; a horizontal transfer operation in which the information charge packets of a single row outputted from the plurality of vertical CCD shift registers are horizontally transferred via the horizontal CCD shift register by using the line transfer operation; and an information charge holding operation in which information charge packets in the vertical CCD shift registers are held in currently positioned bits in an period of time during which the horizontal transfer operation is performed. The information charge holding operation comprises a first storage operation in which the information charge packets under m₁ transfer electrodes selected from a set of transfer electrodes disposed in each bit of the vertical CCD shift registers are stored during a first period that begins following the immediately preceding line transfer operation and ends midway through the horizontal transfer operation; and a second storage operation in which the information charge packets under m₂ electrodes, whose number is greater than m₁ and which are selected from the set of transfer electrodes, are stored during a second period that begins following the first period and ends at the start of period the subsequent line transfer operation.

### BRIEF DESCRIPTION OF THE DRAWINGS

FIG. 1 is a timing chart showing the waveforms of the clock signals in a conventional method for driving a frame-transfer CCD image sensor having a distribution mechanism between a storage section and a horizontal transfer section;

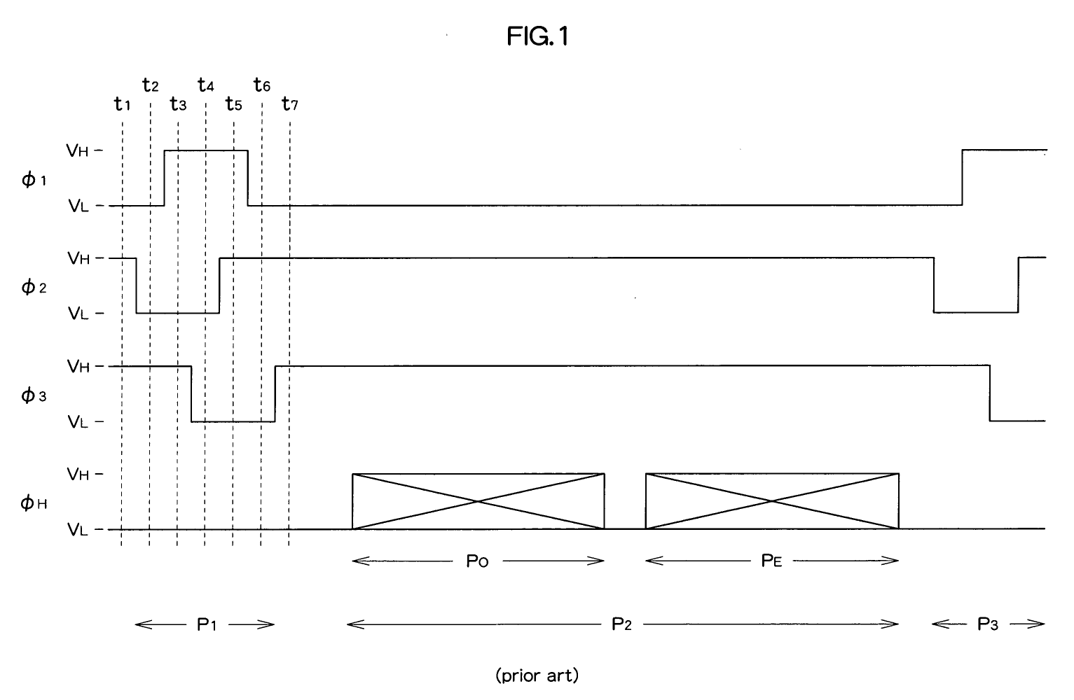

FIG. 2 is a schematic diagram showing a change in channel potential in the conventional driving method;

FIG. 3 is a block diagram showing the general configuration of an imaging device as an embodiment of the present invention;

FIG. 4 is a plan view showing the general structure of the storage section, the distribution section, and the horizontal transfer section of the image sensor;

FIG. 5 is a timing chart showing the waveforms of the clock signals in the operation in which the information charges that have been frame-transferred to the storage section are read to the horizontal transfer section;

FIG. 6 is a schematic diagram showing changes in the channel potential in the charge transfer channels of odd-numbered columns; and

FIG. 7 is a schematic diagram showing changes in the channel potential in the charge transfer channels of even-numbered columns.

### DESCRIPTION OF THE PREFERRED EMBODIMENTS

Embodiments of the present invention (hereinafter referred to as “embodiments”) are described below with reference to the diagrams.

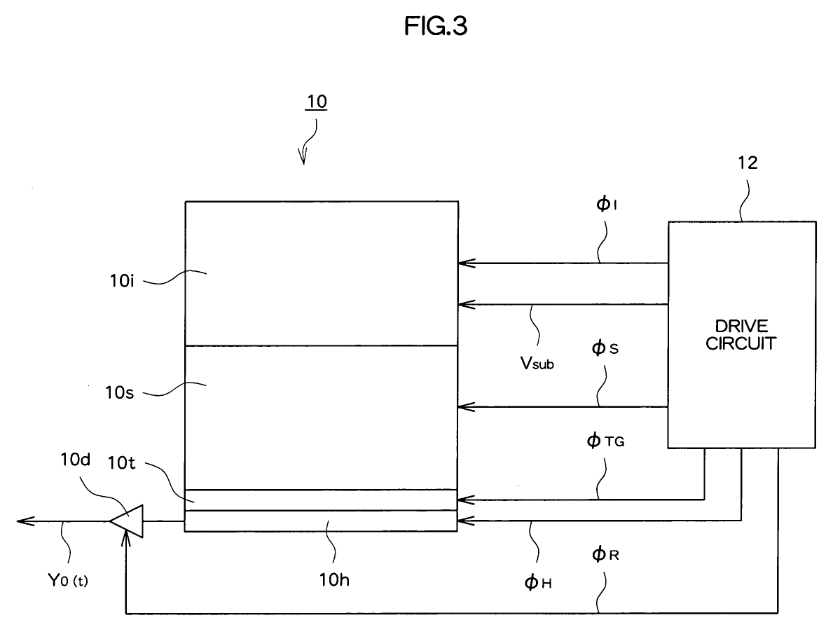

FIG. 3 is block diagram showing the general configuration of an imaging device as an embodiment. The imaging device includes an image sensor 10 and a drive circuit 12, and outputs image signals from the image sensor 10.

The image sensor 10 is a frame-transfer CCD shift register having an imaging section 10i, a storage section 10s, a horizontal transfer section 10h, an output section 10d, and a distribution section 10t.

The imaging section 10i and storage section 10s are composed of vertical CCD shift registers in which mutual charge transfer channels are made mutually continuous in the column direction, and a plurality of these vertical CCD shift registers are arrayed in the row direction (the horizontal direction of the image) in the imaging section 10i and the storage section 10s. These vertical CCD shift registers are provided with a plurality of gate electrodes as transfer electrodes across a substrate in the row direction and are arrayed in parallel in the column direction. The bits of the vertical CCD shift registers of the imaging section 10i constitute light-receiving pixels, and generate and accumulate single charges in accordance with the incident light. The storage section 10s is covered with a light-shielding film to prevent charges from being generated by incident light. Therefore, the storage section 10s is able to store signal charges frame-transferred from the imaging section 10i essentially without change.

The distribution section 10t is positioned between the output terminals of the storage section 10s and the horizontal transfer section 10h, and is composed of a charge transfer channel that extends from the vertical CCD shift registers of the storage section 10s, and a plurality of transfer gate electrodes (TG electrodes) that can be driven independently from the storage section 10s. The distribution section 10t is a mechanism for distributing information charges. The section separates a single row of information charge packets outputted from the vertical CCD shift register group of the storage section 10s into a group of information charge packets of odd-numbered columns and a group of information charge packets of even-numbered columns, and transfers each of these groups to the horizontal transfer section 10h.

The horizontal transfer section 10h is composed of a CCD shift register, and the bits of the CCD shift register are connected to the output terminals of the charge transfer channels of the distribution section 10t.

The output section 10d is composed of an electrically isolated capacitor and an amplifier for extracting potential changes of the capacitor. The signal charge outputted from the horizontal transfer section 10h is received by the capacitor in single bit units, converted to a voltage value, and outputted as a time series image signal Y0(t).

The drive circuit 12 generates clock signals and voltage signals, and drives the image sensor 10. The drive circuit 12 feeds transfer clocks φ_{I} having a plurality of phases to the transfer electrodes of the vertical CCD shift registers of the imaging section 10i, and feeds transfer clocks φ_{S} having a plurality of phases to the transfer electrodes of the vertical CCD shift registers of the storage section 10s. The storage and transfer of information charges in the imaging section 10i and storage section 10s are controlled by these transfer clocks. The drive circuit 12 generates clocks φ_{TG} that are applied to the TG electrodes, clocks φ_{H} that drive the horizontal transfer section 10h, a clock φ_{R} that drives the reset gate of the output section 10d, a substrate voltage Vsub that is applied to the n-type semiconductor substrate, and other outputs.

Three transfer electrodes are disposed in each bit of the vertical CCD shift registers of the image sensor 10. A color filter array is disposed in the imaging section 10i, and the bits of the vertical CCD shift registers of the imaging section 10i constitute light-receiving pixels provided with a color filter of a specific color for each bit. For example, a color filter array in the form of a Bayer array is disposed on the imaging section 10i, and two types of light-receiving pixels having different color sensitivity characteristics are alternately disposed in each row of the imaging section 10i.

In the imaging section 10i, nine transfer electrodes are configured so as to be able to be driven independently from each other for each continuous group of three bits in each of the vertical CCD shift registers in order to make it possible to obtain images in which pixels are skipped in video imaging or in a preview. In still imaging, standard three-phase driving is carried out so that three transfer electrodes of each bit are driven using clocks having mutually different phases. On the other hand, in video imaging and previews, a three-line synthesis driving in which signal charges are added and synthesized in three continuous pixel units in the column direction of the imaging section 10i, and then the signal charges are frame-transferred is performed. For example, pixels are added so that the center pixel of three pixels is skipped, and the signal charges of pixels disposed on the two sides and provided with mutually the same color are added. Specifically, this pixel addition involves applying an off-voltage to three transfer electrodes of the center pixel of three pixels, whereby a signal charge accumulated in the pixel is discharged to the substrate to which a relatively high positive substrate voltage Vsub has been applied, and the signal charges accumulated in the two pixels to the two sides of the center pixel are thereafter combined. In a pixel compression operation, the additive synthesis is carried out in units of three pixels in the above manner and then a three-phase drive operation is carried out. In the three-phase drive operation, clocks having the same phase are applied to the three transfer electrodes of each bit of the imaging section 10i and storage section 10s, and clocks having a different phase are applied to the adjacent bits. With the three-line synthesis driving, the number of substantially vertically arranged pixels can be reduced to ⅓ in comparison with still imaging, triple speed frame transfer is performed using the same clock frequency as that used during standard driving, and the number of line transfers is reduced to ⅓.

The driving method of the present invention reduces longitudinal striping and color mixing and improves image quality. The method can be applied to still imaging, video imaging, and previewing. The present invention is particularly effective for still imaging, where a higher level of image quality is required but image quality degrades more easily because of the considerable number of line transfers. In view of this situation, the driving method of the present invention is described in detail below for a case of still imaging.

The light-receiving pixels of the imaging section 10i generate and accumulate signal charges in accordance with incident light during the exposure period. The drive circuit 12 drives the vertical CCD shift registers of the imaging section 10i and the storage section 10s by using the three-phase clocks φ_{I} and φ_{S} when the set exposure period has elapsed, and frame-transfers the information charges from the imaging section 10i to the storage section 10s. The drive circuit 12 repeatedly carries out the line transfer operation and the horizontal transfer operation, whereby the signal charges of a single screen transferred to the storage section 10s are read one row at a time and converted to image signals. Among the driving operations carried out by the drive circuit 12, the primary difference from conventional driving methods is the line transfer operation in the storage section 10s that is performed after the frame transfer operation, and a description of this difference is described in detail below.

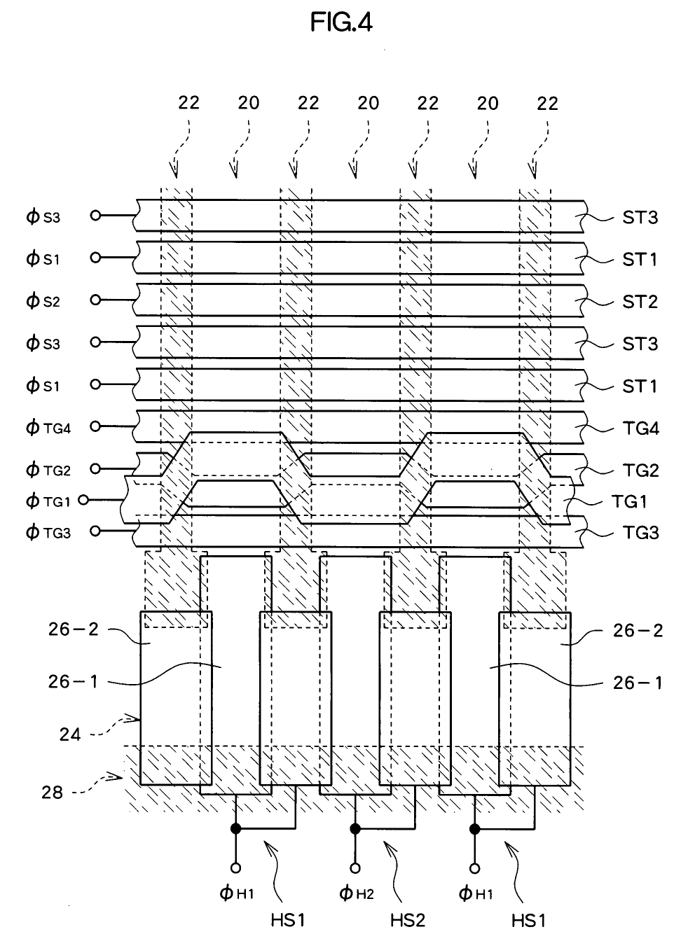

FIG. 4 is plan view showing the general structure of the storage section 10s, the distribution section 10t, and the horizontal transfer section 10h of the image sensor 10. Channel regions 20 that extend in the column direction of the vertical CCD shift registers of the storage section 10s are mutually separated by channel stop regions 22. Three transfer electrodes ST1 to ST3 are disposed in each bit of the storage section 10s. The transfer electrodes ST1 to ST3 are aligned in sequence along the charge transfer direction, and clock signals φ_{Si} (i=1 to 3) are applied from the drive circuit 12 to the transfer electrodes STi.

The transfer electrode ST1 adjacent to the transfer electrode ST3 of the final bit of the vertical CCD shift registers of the storage section 10s, and the four TG electrodes TG1 to TG4 are disposed in the distribution section 10t. TG1 and TG2 have serpentine shapes in which the mutual positions in the column direction are alternately inverted in each column. TG4 is disposed between the transfer electrode ST1 provided to the distribution section 10t and the two electrodes TG1 and TG2. TG3 is disposed between the horizontal transfer section 10h and the two electrodes TG1 and TG2. TG3 and TG4 have a linear shape that extends in the row direction. In the channel regions 20 of the odd-numbered columns, TG1 controls the channel potential of the region between TG4 and TG2, and TG2 controls the channel potential of the region between TG1 and TG3. Conversely, in the channel regions 20 of the even-numbered columns, TG2 controls the channel potential of the region between TG4 and TG1, and TG1 controls the channel potential of the region between TG2 and TG3. Clock signals φ_{TGi} (i=1 to 4) are applied from the drive circuit 12 to the TG electrode TG1.

The horizontal CCD shift register constituting the horizontal transfer section 10h is composed of channel regions 24 and horizontal transfer electrodes 26-1 and 26-2. The channel regions 24 are in contact with the channel regions 20 and channel stop regions 22 on the side of the distribution section 10t, and the boundaries on the opposite side are in contact with a channel stop region 28. The horizontal transfer electrodes 26-1 are disposed between TG3 and the channel stop region 28, and are disposed in the portions of the channel regions 24 that are connected to the channel regions 20. The horizontal transfer electrodes 26-2 are disposed so as to cover the channel regions 24 between two horizontal transfer electrodes 26-1. The horizontal CCD shift register is driven in two phases. The channel regions 24 corresponding to the horizontal transfer electrodes 26-1 constitutes a storage region in which information charges are accumulated. The channel regions 24 corresponding to the horizontal transfer electrodes 26-2 constitute barrier regions in which impurities have been implanted to bring the channel potential below that of the storage region. A pair of electrodes composed of the mutually adjacent horizontal transfer electrodes 26-1 and 26-2 are electrically connected to each other. A horizontal transfer clock φ_{H1} is applied to the electrode pair HS1 in a position that corresponds to the channel regions 20 of the odd-numbered columns, and a horizontal transfer clock φ_{H2} is applied to the electrode pair HS2 in a position that corresponds to the channel regions 20 of the even-numbered columns.

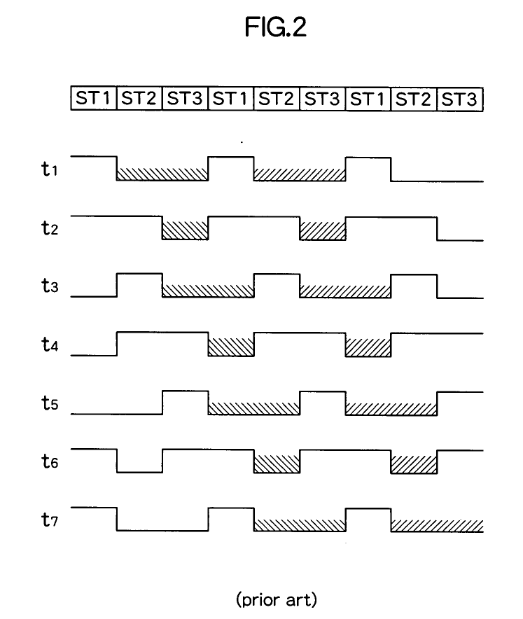

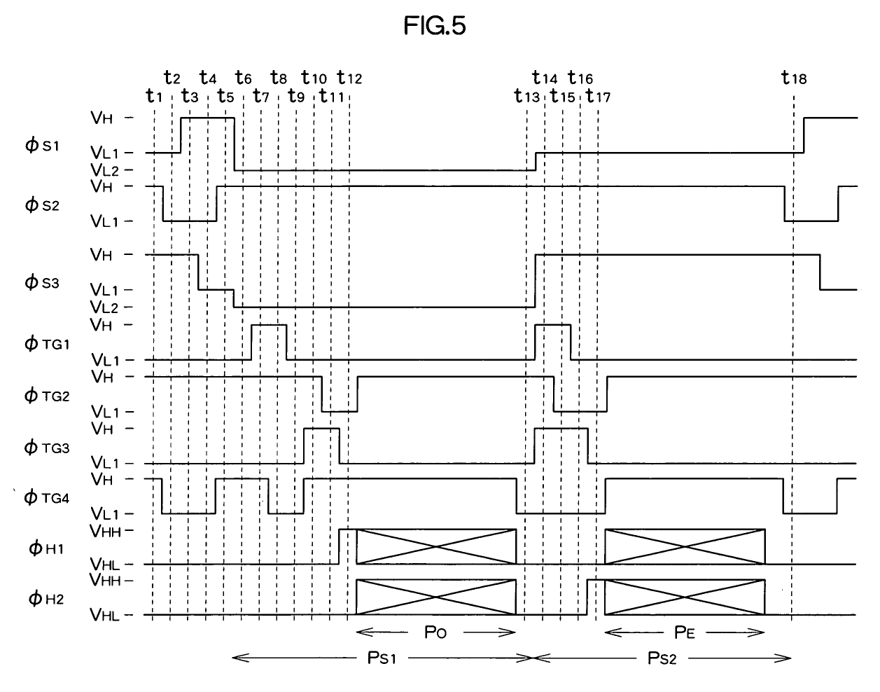

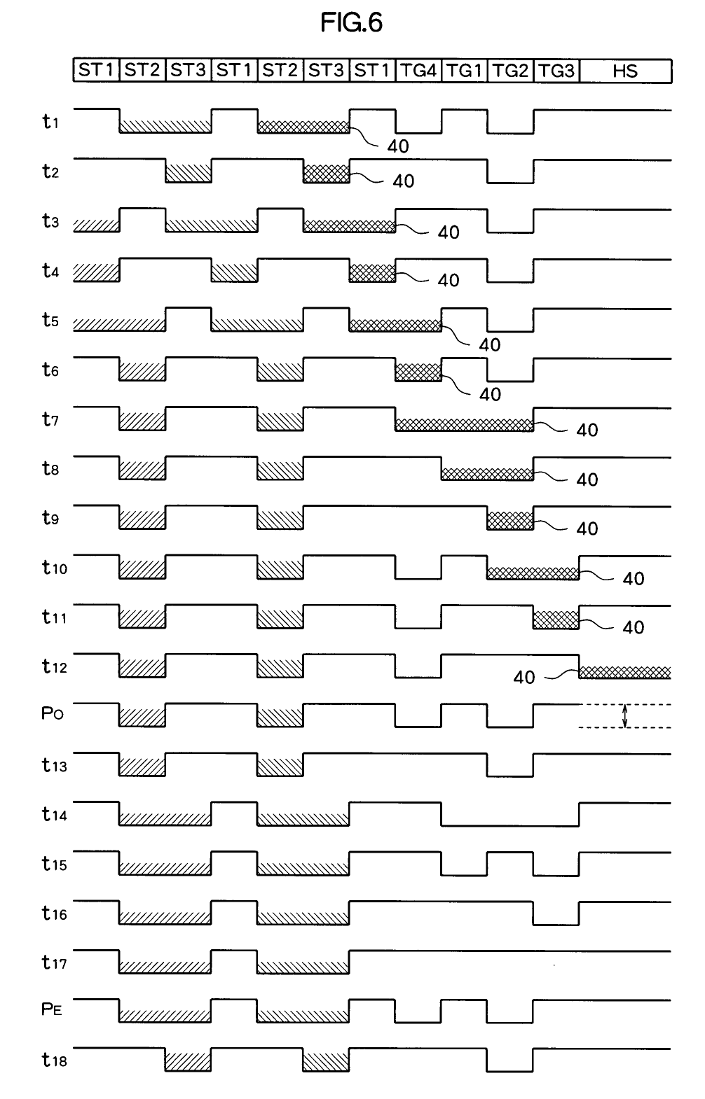

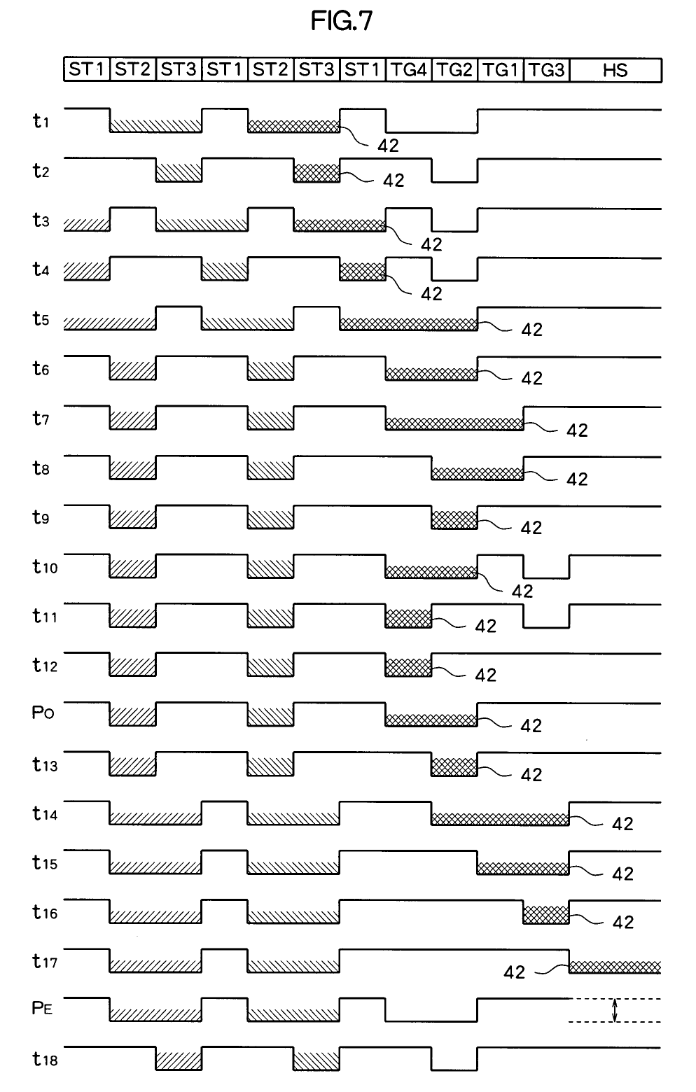

FIG. 5 is a timing chart of the operation in which the information charges that have been frame-transferred to the storage section 10s are read out to the horizontal transfer section 10h. The chart shows the waveforms of the clock signals that drive the storage section 10s, distribution section 10t, and horizontal transfer section 10h. FIGS. 6 and 7 are schematic diagrams showing the channel potential under the transfer electrodes at each point in time shown in FIG. 5. FIG. 6 is a diagram related to the charge transfer channels of odd-numbered columns, and FIG. 7 is a diagram related to the charge transfer channels of even-numbered columns. The arrays of the transfer electrodes along the charge transfer channels are shown at the topmost portion of FIGS. 6 and 7, and the channel potentials under the transfer electrodes are displayed therebelow in the vertical direction in a chronological fashion. The rightward direction in FIGS. 6 and 7 correspond to the charge transfer direction. The channel potential is positive in the downward direction in the same manner as FIG. 2, and the solid line represents changes in the depth of the channel potentials along the charge transfer channels. Portions in which the solid line is depressed are potential wells that can store information charges composed of electrons. The information charges stored in the potential wells are indicated by diagonal lines or lattice patterns.

The drive circuit 12 generates an on-voltage V_{H} and two off-voltages V_{L1} and V_{L2} for the clock signals φ_{Si} (i=1 to 3), and outputs V_{H}, V_{L1}, or V_{L2} as the φ_{Si} in accordance with timing. In this case, the on-voltage V_{H} is a prescribed positive voltage, the channel potential under the transfer electrode to which the voltage is applied is made deeper, and a potential well that can store electrons is formed under the transfer electrode. The two off-voltages V_{L1} and V_{L2} have a magnitude relationship in which V_{H}>V_{L1}>V_{L2}. The off-voltage in the frame transfer operation and the line transfer operation is set to V_{L1}. The off-voltage V_{L2}, which is set to a prescribed negative voltage, is used in the holding of the information charges in the storage section 10s during the horizontal transfer operation as described below. V_{L2} is set to a voltage at which a hole-accumulating inverted layer is formed on the substrate surface under the transfer electrodes to which the voltage is applied in a fashion similar to a pinning voltage.

The drive circuit 12 generates an on-voltage V_{H} and an off-voltage V_{L1} in relation to the clock signals φ_{TGi} (i=1 to 4), and outputs V_{H} or V_{L1} as the φ_{TGi} in accordance with timing. The drive circuit 12 also generates an on-voltage V_{HH} and an off-voltage V_{HL} (V_{HH}>V_{HL}) for the clock signals φ_{Hi} (i=1 or 2), and outputs V_{HH} or V_{HL} as the φ_{Hi} in accordance with timing. The channel potentials in the channel regions 20 under STi and TGi during application of V_{H} may not necessarily be the same as the channel potential of the storage region HSi during application of V_{HH}, and the channel potentials under STi and TGi during application of V_{L1} may not necessarily be the same as the channel potential of the storage region HSi during application of V_{HL}. However, for the sake of convenience, FIGS. 6 and 7 shows a case in which the channel potentials of the storage regions of the horizontal transfer section 10h and the channel regions 20 involved in the vertical transfer are mutually the same during application of an on-voltage, as well as a case in which the channel potentials are mutually the same during application of an off-voltage.

At time t₁, the sections of the image sensor 10 are in a state that existed immediately after the frame transfer operation or in a state in which the preceding horizontal transfer operation has been completed. In this state, the information charges held in the storage section 10s are accumulated in the potential wells formed under the transfer electrodes ST2 and ST3. Subsequent to this state, a line transfer operation is carried out. The line transfer operation is carried out in the period between time t₁ and time t₆ in FIGS. 5 to 7, and the information charges held in the bits of the vertical CCD shift registers of the storage section 10s are moved toward the horizontal transfer section 10h one bit at a time. This operation will now be described in detail. The information charges accumulated under ST2 and ST3 of a certain bit at time t₁ passes through a state (time t₂) in which φ_{S2} changes (time t₃) from an on-voltage V_{H} to an off-voltage V_{L1}, and φ_{S1} changes (time t₂) from V_{L1} to V_{H}. The information charges are thereby accumulated only under ST3 and moved (time t₃) to the potential wells formed under ST3 and ST1 of the next bit. Similarly, φ_{S3} changes (time t₄) to V_{L1}, and φ_{S2} changes (time t₅) from V_{L1} to V_{H}, whereby the information charges pass from a state in which the information charges are accumulated under ST3 and ST1 at time t₃ to a state (time t₄) in which the information charges are temporarily accumulated only under ST1, and move to the potential wells formed under ST1 and ST2 of the next bit (time t₅).

In the present driving method, information charges accumulated under ST1 and ST2 are subsequently collected solely under ST2 (time t₆), the line transfer operation is ended in this state, and the horizontal transfer operation is started. Specifically, the line transfer operation moves the information charges held under ST2 and ST3 of a certain bit to a potential well formed only under ST2 of the next bit. The storage section 10s thereby holds the information charges in a potential well that is narrower than a convention potential well at the start of the horizontal transfer operation.

In contrast, a conventional driving method ends the line transfer operation at the stage in which the information charges accumulated under ST1 and ST2 are moved to the potential wells formed under ST2 and ST3 via a state in which the information charges are accumulated only under ST2. Specifically, a conventional line transfer operation moves information charges held under ST2 and ST3 of a certain bit to potential wells formed under ST2 and ST3 of the next bit, and the horizontal transfer operation is started in a state in which the information charges are held in the potential wells. This is one difference between the present drive method and the conventional drive method.

The information charges 40 and 42 held in the bits of the output terminal of the vertical CCD shift registers of the storage section 10s are moved to the distribution section 10t by way of the line transfer operation.

As referred to herein, the horizontal transfer operation includes an operation in which the distribution section 10t distributes information charge packets of odd-numbered columns and information charge packets of even-numbered columns, and outputs the packets to the horizontal CCD shift register (distribution operation), and an operation in which the distributed and outputted information charge packets are horizontally transferred to the horizontal CCD shift register (narrowly-defined horizontal transfer operation). Specifically, after the line transfer operation has been completed, the drive circuit 12 sequentially carries out the following operations as the horizontal transfer operation: an odd-numbered column distribution transfer operation (times t₇ to t₁₂) that transfers the information charges 40 of the odd-numbered columns from the distribution section 10t to the horizontal CCD shift register, an odd-numbered column horizontal transfer operation (period P_{O}) that drives the horizontal CCD shift register and horizontally transfers the information charges 40 of the odd-numbered columns, an even-numbered column distribution transfer operation (times t₁₃ to t₁₇) that transfers the information charges 42 of the even-numbered columns from the distribution section 10t to the horizontal CCD shift register, and an even-numbered column horizontal transfer operation (period P_{E}) that drives the horizontal CCD shift register and horizontally transfers the information charges 42 of the even-numbered columns.

During the horizontal transfer operation, the information charges held in the bits of the storage section 10s are stored only under a single transfer electrode ST2 when the line transfer operation is completed as described above, but after a prescribed time has elapsed, the drive circuit 12 changes φ_{S3} to V_{H} and stores information charges in the potential wells formed under ST2 and ST3 until the next line transfer operation begins. In other words, the drive circuit 12 switches between a first storage operation in which information charges are stored under a single transfer electrode selected from a set of transfer electrodes disposed in each bit of the vertical CCD shift registers of the storage section 10s during a first period that begins when the line transfer operation has been completed and ends midway through the horizontal transfer operation, and a second storage operation in which information charges under two electrodes, whose number is greater than that used during the first storage operation and which are selected from the set of transfer electrodes, are stored during a second period that begins following the first period and ends when the next line transfer operation begins.

As described above, the information charges are stored up to the vicinity of the surface of the substrate and are more easily trapped in the interface state with timing of midway through the line transfer operation in which the potential wells become narrow. In the interface state, the information charges of preceding bits that have passed by in the line transfer operation are trapped and the information charges are released into the potential wells of subsequent bits, potentially resulting in color mixing. The first storage operation is designed to reduce this problem. Narrow potential wells that store information charges are formed, whereby trapped charges released under transfer electrodes that correspond to the potential wells are reduced and color mixing is inhibited. Therefore, the first period P_{S1} in which the first storage operation is performed is preferably set to last longer than the period in which trapped charges tend to be released after the line transfer has been completed. With the second storage operation, the amount of information charges trapped by the second storage operation can be reduced, and the information charges already trapped in the first storage operation can be released in the original potential wells, by widening the potential wells and moving the information charges away from the surface of the substrate. The occurrence of trapping in the holding of information charges in the storage section 10s is reduced during the horizontal transfer operation, and longitudinal striping can be reduced. Therefore, the second period P_{S2} needed to perform the second storage operation must be maintained a certain amount of time, and the first period P_{S1} is preferably set with consideration given to this point.

With the driving method of the present embodiment, in addition to the above-described points, timing is established for switching between the first storage operation and the second storage operation with consideration given to the fact that the image signal is easily affected by noise during reading by horizontal transfer when the state of φ_{S} is switched midway through the horizontal transfer operation for odd-numbered columns and the horizontal transfer operation for even-numbered columns. Specifically, the drive circuit 12 switches between a first storage operation and a second storage operation in accordance with the timing between the period P₀ of the horizontal transfer operation of the odd-numbered columns and the period P_{E} of the horizontal transfer operation of the even-numbered columns. For example, this switch can be made in synchronization with the start of the distribution and transfer of even-numbered columns. The drive circuit 12 controls the holding of the information charges in the storage section 10s, under the condition that the first period P_{S1} begins at the end of the line transfer operation and ends at the start of the distribution operation for the even-numbered columns, and that the second period P_{S2} begins at the start of the distribution operation for the even-numbered columns and ends at the start of the subsequent line transfer operation. In this case, the drive circuit 12 maintains a state at the completion of the line transfer operation in which only the clock φ_{S2} is an on-voltage V_{H} while the remaining φ_{S1} and φ_{S3} are each an off-voltage until a timing between time t₁₃ and time t₁₄ that φ_{TG1} and φ_{TG3} switch to an on-voltage, and switches φ_{S3} to the on-voltage V_{H} in accordance with the timing.

In this case, the transfer electrode ST2 of each bit of the vertical CCD shift registers of the storage section 10s in the first period P_{S1} forms a potential well, while ST1 and ST3 form potential barriers at each side of the potential well. The off-voltage of the φ_{S1} and φ_{S3} applied to ST1 and ST3 can be set to V_{L1}, which is one of the two voltages described above, in order to form the potential barriers, but is set to the lower V_{L2} in the present embodiment. Holes collect on the surface of the substrate under ST1 and ST3 to which V_{L2} has been applied, and a recombination of the holes and the trapped charges generated in the line transfer operation is facilitated. The release of trapped charges under the transfer electrodes ST1 and ST3 is reduced and the amount of charge that is released from the interface state and caused to flow into the potential well under the adjacent ST2 is therefore reduced as well, resulting in reduced color mixing.

Embodiments of the method for driving the image sensor 10 in still imaging were described above, but as already stated, the present invention can also be used to perform driving in video imaging and previewing. In this case, the drive circuit 12 forms a single potential well for every nine transfer electrodes of the vertical CCD shift registers of the storage section 10s as described above, and shifts the potential well by three-phase driving. In this driving method, the first storage operation involves applying an on-voltage to three transfer electrodes disposed in sequence in correspondence with a single phase of the transfer clock, and holding the information charges in the potential well formed thereby. The second storage operation involves applying an on-voltage to six transfer electrodes disposed in sequence in correspondence with two phases of the transfer clock, and holding the information charges in the potential well formed thereby. Color mixing and longitudinal striping can thereby be reduced in the same manner as in the still imaging described above.

The present invention can also be applied to a method for driving a CCD image sensor that is capable of separating a single row of information charge packets into three or more groups of information charge packets and transferring each of the groups to a horizontal CCD shift register. In driving a CCD image sensor that separates a single row of information charge packets into three groups of information charge packets and transferring each of the groups to a horizontal CCD shift register, a drive circuit can, for example, divide a horizontal transfer operation for a single row into first to third partial horizontal transfer operations corresponding to three groups of the information charge packets. In this driving, the switch between the first accumulation operation and the second accumulation operation can be made in the interval between the first partial horizontal transfer operation and the second partial horizontal transfer operation, or in the interval between the second partial horizontal transfer operation and the third partial horizontal transfer operation. The particular switching interval between the three or more partial horizontal transfer operations can be determined in accordance with a time constant of the process in which the interface state releases charges that have been trapped midway through the line transfer operation. In other words, the period in which trapped charges are easily released following a line transfer is determined in accordance with the time constant, and the first period P_{S1} can be designed to end during the partial horizontal transfer operation that comes immediately after the easy-release period.

The driving method of the present invention may be applied not only to an image sensor having three-phase drive vertical CCD shift registers, but also to an image sensor having four- or higher-phase drive vertical CCD shift registers. An interline CCD image sensor reads information charges produced by photodiodes into an adjacent vertical CCD shift register, and drives the vertical CCD shift register one bit at a time for each horizontal transfer operation of a single row. The operation of the vertical CCD shift registers in an interline image sensor is similar to that of the storage section 10s in a frame-transfer CCD image sensor, and the present invention can be applied to reduce color mixing and longitudinal striping and to improve image quality.

The method for driving a solid-state image sensor according to the present invention as described above relates to a method for driving a solid-state image sensor having a plurality of n-phase (wherein n is a natural number of 3 or more) drivable vertical CCD shift registers in which information charge packets composed of information charges generated in a matrix of light-receiving pixels are vertically driven in the column direction, and a horizontal CCD shift register in which the information charge packets outputted from the plurality of vertical CCD shift registers are horizontally transferred in the row direction. The driving method of the present invention has a line transfer operation in which the information charge packets are vertically transferred one row at a time by moving the information charge packets in the vertical CCD shift registers one bit at a time; a horizontal transfer operation in which the information charge packets of a single row outputted from the plurality of vertical CCD shift registers are horizontally transferred via the horizontal CCD shift register by using the line transfer operation; and an information charge holding operation in which information charge packets in the vertical CCD shift registers are held in currently positioned bits in an period during which the horizontal transfer operation is performed. The information charge holding operation includes a first storage operation in which the information charge packets under m₁ transfer electrodes selected from a set of transfer electrodes disposed in each bit of the vertical CCD shift registers are stored during a first period that begins following the immediately preceding line transfer operation and ends midway through the horizontal transfer operation; and a second storage operation in which the information charge packets under m₂ electrodes, whose number is greater than m₁ and which are selected from the set of transfer electrodes, are stored during a second period that begins following the first period and ends at the start of the period of the subsequent line transfer operation.

The method for driving according to the present invention can be applied to driving a solid-state image sensor that includes a distribution and transfer mechanism for separating a single row of information charge packets outputted from the plurality of vertical CCD shift registers via the line transfer operation into first to k^{th} (where k is a natural number of 2 or higher) information charge packet groups, and sequentially transferring each of the information charge packet groups to the horizontal CCD shift register. In such a case, the horizontal transfer operation sequentially carries out first to k^{th} partial horizontal transfer operations to horizontally transfer each of the first to k^{th} information charge packet groups. The information charge holding operation switches from the first storage operation to the second storage operation in synchronism with any of the k-1 intervals between the partial horizontal transfer operations.

For example, in the embodiments described above, the driving method of the present invention for a solid-state image sensor was described having a distribution transfer mechanism in which a single row of information charge packets outputted from the plurality of vertical CCD shift registers by a line transfer operation is separated into information charge packet groups corresponding to odd-numbered columns and information charge packet groups corresponding to even number columns, and the information charge packet groups are sequentially transferred to the horizontal CCD shift register. In this driving method, the horizontal transfer operation involves sequentially performing an odd-numbered column horizontal transfer operation that horizontally transfers the information charge packet groups of the odd-numbered columns, and an even-numbered column horizontal transfer operation that horizontally transfers the information charge packet groups of the even-numbered columns. The information charge holding operation switches from the first storage operation to the second storage operation in synchronism with the period between the odd-numbered column horizontal transfer operation and the even-numbered column horizontal transfer operation.

In the driving method described above, the length of the first period is preferably set in accordance with a time constant of a process for releasing charges trapped by the interface state of a semiconductor substrate constituting the channels of vertical CCD shift registers.

The driving method, when applied to a solid-state image sensor in which vertical CCD shift registers can be driven in three phases, may be configured so that the first storage operation stores the information charge packets under the transfer electrode corresponding to a single phase of the three-phase driving, and the second storage operation stores information charge packets under the transfer electrodes corresponding to two phases of three-phase driving.

In the embodiments described above, a driving method was described in which V_{L2}, which is the off-voltage that is applied during the first storage operation and is lower than the voltage V_{L1} used as the off-voltage of the transfer clock in the line transfer operation, is applied to ST1 and ST3. The off-voltage applied during the first storage operation can be set to a value that corresponds to a pinning voltage in which an inverted layer is formed on the surface of the semiconductor under the transfer electrodes.

In accordance with the present invention as described above, the operation for holding the information charges in the vertical CCD shift registers following the line transfer operation is an operation for storing information charges in narrow potential wells in the period (first period) that lasts midway through the horizontal transfer operation, and storing information charges in wide potential wells in the subsequent period (second period). The release of the trapped charges can be expected to be reduced over time after the charges are trapped. In view of the above, the potential wells are made narrower in the first period in which charges trapped midway through the line transfer operation are easily released. The amount of trapped charges released under the transfer electrodes corresponding to the potential wells can thereby be reduced, the amount of trapped charges that flow from under the transfer electrodes directly into the potential wells can be lowered, and color mixing can be reduced. On the other hand, the potential wells are widened in the second period that follows the first period, and the information charges are moved away from the surface of the substrate. The amount of trapped information charges from the potential wells in the holding operation can thereby reduced, and the information charges already trapped from the potential wells in the first period can be released into the original potential wells. Trapping occurrences in the holding operation can thereby be reduced and longitudinal striping can be lessened.

In the first period, an off-voltage that is used during the first storage operation and is set below the off-voltage of the transfer clock in the line transfer operation is applied to the transfer electrodes that form potential barriers adjacent to the potential wells that store information charges. The generation of holes whose polarity is opposite to that of the information charges is thereby facilitated under the transfer electrodes, and the holes and the trapped charges generated in the line transfer operation can recombine with greater ease. The amount of trapped charges under the transfer electrodes that are released and caused to flow into adjacent potential wells can be lowered and color mixing can be reduced.

1. A method for driving a solid-state image sensor having a plurality of n-phase (wherein n is a natural number of 3 or more) drivable vertical CCD shift registers in which information charge packets composed of information charges generated in a matrix of light-receiving pixels are vertically transferred in the column direction, and a horizontal CCD shift register in which the information charge packets outputted from the plurality of vertical CCD shift registers are horizontally transferred in the row direction, the method comprising:
a line transfer operation in which the information charge packets are vertically transferred one row at a time by shifting the information charge packets in the vertical CCD shift registers one bit at a time;
a horizontal transfer operation in which the information charge packets of a single row outputted from the plurality of vertical CCD shift registers are horizontally transferred via the horizontal CCD shift register by the line transfer operation; and
an information charge holding operation in which the information charge packets in the vertical CCD shift registers are held in currently positioned bits in an period during which the horizontal transfer operation is performed, wherein
the information charge holding operation comprises:
a first storage operation in which the information charge packets under m₁ transfer electrodes selected from a set of transfer electrodes disposed in each bit of the vertical CCD shift registers are stored during a first period that begins following the immediately preceding line transfer operation and ends midway through the horizontal transfer operation; and
a second storage operation in which the information charge packets under m₂ electrodes, whose number is greater than m₁ and which are selected from the set of transfer electrodes, are stored during a second period that begins following the first period and ends at the start of a subsequent line transfer operation.

2. The method for driving a solid-state image sensor of claim 1, comprising a distribution transfer mechanism for separating a single row of the information charge packets outputted from the plurality of vertical CCD shift registers via the line transfer operation into first to k^{th} (where k is a natural number of 2 or higher) information charge packet groups, and sequentially transferring each of the information charge packet groups to the horizontal CCD shift register, wherein
the horizontal transfer operation sequentially carries out first to k^{th} partial horizontal transfer operations to horizontally transfer each of the first to k^{th} information charge packet groups; and
the information charge holding operation switches from the first storage operation to the second storage operation in synchronism with any of the k-1 intervals between the partial horizontal transfer operations.

3. The method for driving a solid-state image sensor of claim 1, wherein
the length of the first period is set in accordance with a time constant of a process for releasing charges trapped by interface states of a semiconductor substrate constituting channels of vertical CCD shift registers.

4. The method for driving a solid-state image sensor of claim 1, comprising a distribution transfer mechanism for separating a single row of the information charge packets outputted from the plurality of vertical CCD shift registers via the a line transfer operation into information charge packet groups corresponding to odd-numbered columns and information charge packet groups corresponding to even-number columns, and sequentially transferring each of the information charge packet groups to the horizontal CCD shift register, wherein
the horizontal transfer operation involves sequentially performing an odd-numbered column horizontal transfer operation that horizontally transfers the information charge packet groups of the odd-numbered columns, and an even-numbered column horizontal transfer operation that horizontally transfers the information charge packet groups of the even-numbered columns; and
the information charge holding operation switches from the first storage operation to the second storage operation in synchronism with the interval between the odd-numbered column horizontal transfer operation and the even-numbered column horizontal transfer operation.

5. The method for driving a solid-state image sensor of claim 1, wherein
the vertical CCD shift registers can be driven in three phases;
the first storage operation stores the information charge packets under the transfer electrodes corresponding to a single phase of the three-phase driving; and
the second storage operation stores the information charge packets under the transfer electrodes corresponding to two phases of the three-phase driving.

6. The method for driving a solid-state image sensor of claim 1, wherein an off-voltage that is applied during the first storage operation and is lower than an off-voltage of transfer clocks in the line transfer operation is applied to the transfer electrodes for forming potential barriers against the information charge packets stored in the bits.

7. The method for driving a solid-state image sensor of claim 6, wherein the off-voltage applied during the first storage operation is a value that corresponds to a pinning voltage in which an inverted layer is formed on a surface of a semiconductor under the transfer electrodes.
